(19) United States
(12) Patent Application Publication
(10) Pub. No.: US 2012/0329000 A1
(43) Pub. Date: Dec. 27, 2012

(54) SUBSTRATE PROCESSING APPARATUS, SUBSTRATE PROCESSING METHOD, PROGRAM AND COMPUTER STORAGE MEDIUM

(76) Inventor: Osamu Hirakawa, Koshi City (JP)

(21) Appl. No.: 13/583,017

(22) PCT Filed: Mar. 2, 2011
(86) PCT No.: PCT/JP2011/054733

§ 371 Date: Sep. 6, 2012

(30) Foreign Application Priority Data
Mar. 23, 2010 (JP) 2010-066276

(51) Int. Cl. F27D 3/00

(52) U.S. Cl. 432/5; 432/239

(57) ABSTRACT

The present invention includes: an upper container and a lower container relatively movable and uniting together into one body to form a processing space; a substrate holding part provided inside the lower container and mounting and holding the substrate thereon; and a delivery arm including a support member extending vertically downward from a lower surface of the upper container, and a delivery member supported by the support member and holding an outer peripheral portion of the substrate and delivering the substrate to/from the substrate holding part, wherein the delivery arm is movable together with the upper container in the vertical direction relative to the lower container, and a cutout groove capable of housing the delivery member is formed at a position corresponding to the delivery member at the outer peripheral portion of the substrate holding part.

### TECHNICAL FIELD

The present invention relates to a substrate processing apparatus, a substrate processing method, a program and a computer storage medium.

### BACKGROUND ART

Recently, semiconductor devices become more highly integrated. When a plurality of highly integrated semiconductor devices are arranged within a horizontal plane and connected with one another by wiring into a product, the wiring length may increase to lead to an increase in resistance of the wiring and an increase in wiring delay.

Hence, it is proposed to use the three-dimensional integration technology of stacking the semiconductor devices in three dimensions. In this three-dimensional integration technology, for example, a bonding apparatus is used to join two substrates. The bonding apparatus has a lower chamber in which a substrate holding part is disposed and an upper chamber in which a stage is disposed. In the state that a first substrate and a second substrate are held on the substrate holding part, the upper chamber is lowered toward the lower chamber, and the upper chamber and the lower chamber unite together into one body to form a vacuum chamber. Thereafter, the atmosphere in the vacuum chamber is vacuumed to a predetermined degree of vacuum, then the substrate holding part is raised so that the first substrate and the second substrate are sandwiched and pressed between the substrate holding part and the stage, whereby the first substrate and the second substrate are bonded together (Patent Document 1).
[Patent Document 1] Japanese Laid-open Patent Publication No. 2008-140876

### DISCLOSURE OF THE INVENTION

### Problems to Be Solved by the Invention

Incidentally, when the first substrate is mounted on the substrate holding part, for example, a transfer arm holding the rear surface of the first substrate is used. In this case, when the first substrate is delivered from the transfer arm to the substrate holding part, the transfer arm interferes with the substrate holding part.

Hence, it is conceivable to use, for example, a raising and lowering pin for supporting and raising and lowering the first substrate to avoid the interference. The raising and lowering pin can vertically move by means of a raising and lowering drive part provided outside the lower chamber, for example, via a support member for the raising and lowering pin. At the support member, a sealing member such as an O-ring is provided to bring the inside of the vacuum chamber into a closed space to maintain it at a predetermined degree of vacuum. Further, a through hole penetrating the substrate holding part in its thickness direction is formed in the substrate holding part, and the raising and lowering pin is inserted into the through hole to be able to project from the upper surface of the substrate holding part. Then, after the first substrate is delivered from the transfer arm to the raising and lowering pin above the substrate holding part, the raising and lowering pin is lowered, whereby the substrate is held on the substrate holding part.

However, when mounting the first substrate on the substrate holding part using the raising and lowering pin, the atmosphere below the substrate holding part may flows out to above from the through hole in the substrate holding part together with particles. In this case, due to the particles flowing out to above the substrate holding part, the bonding of the substrates is not appropriately performed.

Further, since the raising and lowering pin is provided in the vacuum chamber, the volume of the vacuum chamber increases to increase the time required to vacuum the inside of the vacuum chamber to the predetermined degree of vacuum. Thus, the throughput of the boding processing increases.

In addition, the sealing material provided at the support member may be low in reliability so that the inside of the vacuum chamber cannot be brought into a complete closed space. In this case, it is difficult to maintain the atmosphere inside the vacuum chamber at the predetermined degree of vacuum. Further, the load when pressing the substrates decreases in proportion to the pressure difference between the actual air pressure of the atmosphere inside the vacuum chamber and the predetermined degree of vacuum. Then, the substrates cannot be appropriately bonded together.

Moreover, when bonding of a plurality of substrates is performed, the time from when the raising and lowering pin is lowered to the time when the upper chamber is lowered may vary, and as a result of this, the bonding processing of the substrates may not be uniformly performed.

The present invention has been made in consideration of the points, and its object is to smoothly and appropriately process a substrate in a substrate processing apparatus having an upper container movable in the vertical direction and a lower container provided below the upper container to face the upper container.

### Means for Solving the Problems

To achieve the above object, the present invention is a substrate processing apparatus, including: an upper container; a lower container provided below the upper container to face the upper container, movable in a vertical direction relative to the upper container, and uniting with the upper container into one body to form a processing space for the substrate therein; a substrate holding part provided inside the lower container and mounting and holding the substrate thereon; and a delivery arm including a support member extending vertically downward from a lower surface of the upper container, and a delivery member supported by the support member and holding an outer peripheral portion of the substrate and delivering the substrate to/from the substrate holding part. The delivery arm is movable together with the upper container in the vertical direction relative to the lower container, and a cutout groove capable of housing the delivery member is formed at a position corresponding to the delivery member at the outer peripheral portion of the substrate holding part.

According to the present invention, the delivery arm is configured to be movable in the vertical direction and the cutout groove is formed at the outer peripheral portion of the substrate holding part, the substrate can be delivered from the delivery arm to the substrate holding part without interference between the delivery arm and the substrate holding part. Further, since the raising and lowering pin in the prior art becomes unnecessary, a through hole for the raising and lowering pin does not need to be formed in the substrate holding part and particles below substrate holding part never flow out to the processing space. Consequently, processing of the substrate can be appropriately performed. Further, the processing space can be made smaller than that in the prior art, so that when the inside of the processing space is brought to a vacuum atmosphere at a predetermined degree of vacuum, the time required to vacuum the inside of the processing space can be reduced. In addition, since the delivery arm is provided at the lower surface of the upper container, the raising and lowering drive part for the raising and lowering pin in the prior art becomes unnecessary and the processing apace can be made into a closed space. This makes it possible to bring the inside of the processing space to the predetermined degree of vacuum. Further, the delivery arm is movable in the vertical direction together with the upper container, so that even when the processing is performed, for example, on a plurality of substrates in sequence in the substrate processing apparatus, it is possible to suppress variation in the substrate processing and improve the stability of the substrate processing. According to the present invention, it is possible to smoothly and appropriately process the substrate as described above.

The present invention according to another aspect is a substrate processing method using a substrate processing apparatus, the substrate processing apparatus including: an upper container; a lower container provided below the upper container to face the upper container, movable in a vertical direction relative to the upper container, and uniting with the upper container into one body to form a processing space for the substrate therein; a substrate holding part provided inside the lower container and mounting and holding the substrate thereon; and a delivery arm including a support member extending vertically downward from a lower surface of the upper container, and a delivery member supported by the support member and holding an outer peripheral portion of the substrate and delivering the substrate to/from the substrate holding part. The substrate processing method includes: lowering the upper container relative to the lower container toward the substrate holding part, and lowering the delivery arm holding the substrate relative to the lower container toward the substrate holding part; housing the delivery member in a cutout groove formed in the substrate holding part, and delivering the substrate from the delivery arm onto the substrate holding part; and performing predetermined processing on the substrate in a state that the delivery member is housed in the cutout groove.

The present invention according to still another aspect is a program running on a computer of a control unit controlling the substrate processing apparatus to cause the substrate processing apparatus to execute the substrate processing method.

The present invention according to yet another aspect is a readable computer storage medium storing the program.

### Effect of the Invention

According to the present invention, in a substrate processing apparatus having an upper container movable in the vertical direction and a lower container provided below the upper container to face the upper container, a substrate can be smoothly and appropriately processed.

### BRIEF DESCRIPTION OF THE DRAWINGS

FIG. 1A longitudinal sectional view illustrating the outline of the configuration of a joint apparatus according to this embodiment.

FIG. 2 A transverse sectional view illustrating the outline of the configuration of the joint apparatus according to this embodiment.

FIG. 3 A perspective view illustrating the outline of the configuration of a delivery arm.

FIG. 4 A plan view illustrating the outline of the configuration of a transfer arm.

FIG. 5 An explanatory view illustrating the appearance that a wafer is delivered between the transfer arm and the delivery arms.

FIG. 6 An explanatory view illustrating the appearance that the wafer is transferred by the transfer arm.

FIG. 7 An explanatory view illustrating the appearance that the wafer is transferred from the transfer arm to the delivery arms.

FIG. 8 An explanatory view near the delivery member illustrating the appearance that the wafer is delivered from the transfer arm to the delivery arm.

FIG. 9 An explanatory view near the delivery member illustrating the appearance that the transfer arm moves.

FIG. 10 An explanatory view illustrating the appearance that the wafer is mounted from the delivery arms to a thermal processing plate.

FIG. 11 An explanatory view near the delivery member illustrating the appearance that the wafer is mounted from the delivery arm to the thermal processing plate.

FIG. 12 An explanatory view illustrating the appearance that the wafer on the thermal processing plate is pressed and joined.

FIG. 13 An explanatory view illustrating the appearance that the delivery arms are raised and the transfer arm is moved into the joint apparatus.

FIG. 14 An explanatory view illustrating the appearance that the wafer is delivered from the delivery arms to the transfer arm.

FIG. 15 A perspective view illustrating the outline of the configuration of a delivery member according to another embodiment.

FIG. 16 A side view illustrating the outline of the configurations of a delivery arm and a thermal processing plate according to another embodiment.

FIG. 17 A transverse sectional view illustrating the outline of the configuration of a joint apparatus according to another embodiment.

FIG. 18 A plan view illustrating the outline of the configuration of a transfer arm according to another embodiment.

FIG. 19 An explanatory view illustrating the appearance that a wafer is delivered between the transfer arm and the delivery arms.

FIG. 20 A longitudinal sectional view illustrating the outline of the configuration of a hydrophobic treatment apparatus according to another embodiment.

FIG. 21 A transverse sectional view illustrating the outline of the configuration of the hydrophobic treatment apparatus according to another embodiment.

FIG. 22 An explanatory view illustrating the appearance that an upper container and a lower container unite together into one body to form a processing space.

FIG. 23 A perspective view illustrating the outline of the configuration of a delivery arm according to another embodiment.

FIG. 24 An explanatory view illustrating the relation between the transfer arm and the delivery arms.

FIG. 25 An explanatory view illustrating the appearance that the wafer is delivered between the transfer arm and the delivery arms.

### BEST MODE FOR CARRYING OUT THE INVENTION

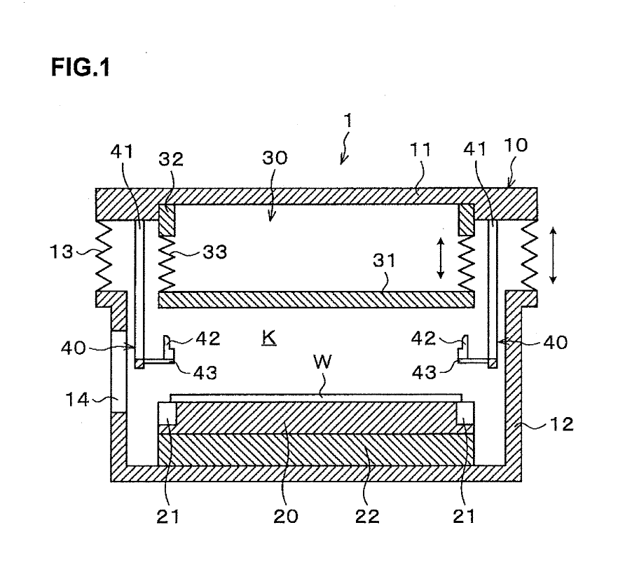

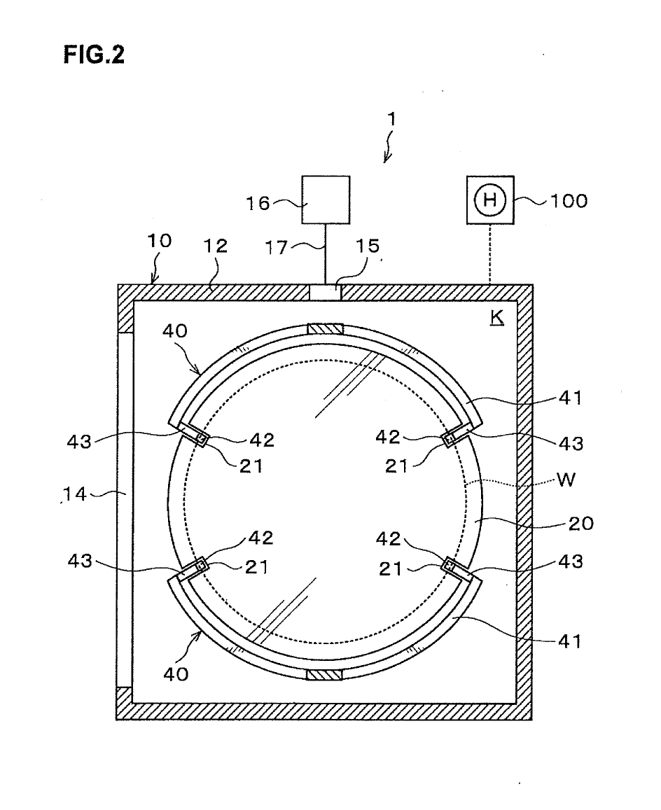

Hereinafter, an embodiment will be described. FIG. 1 is a longitudinal sectional view illustrating the outline of the configuration of a joint apparatus 1 being a substrate processing apparatus according to this embodiment. FIG. 2 is a transverse sectional view illustrating the outline of the configuration of the joint apparatus 1. Note that in the joint apparatus 1 of this embodiment, a superposed wafer W (hereinafter, referred to simply as a “wafer”) as a superposed substrate in which two wafers are superposed is joined.

The joint apparatus 1 has a processing container 10 which can hermetically close its inside as illustrated in FIG. 1. The processing container 10 has such a configuration that an upper container 11 located on the upper side and a lower container 12 located on the lower side are connected to each other by a shield bellows 13. The upper container 11 and the lower container 12 are provided to face each other, and a processing space K for performing joint processing of the wafer W is formed between the upper container 11 and the lower container 12. Further, the shield bellows 13 is configured to freely expand and contract in the vertical direction. By means of the shield bellows 13, the upper container 11 is movable in the vertical direction. Note that though the processing container 10 has a hollow rectangular parallelepiped shape in this embodiment, the processing container 10 is not limited to this shape but may have, for example, a hollow cylindrical shape.

A transfer-in/out port 14 for the wafer W is formed in a side surface of the lower container 12, and a gate valve (not illustrated) is provided at the transfer-in/out port 14.

In a side surface of the lower container 12, a suction port 15 is formed as illustrated in FIG. 2. To the suction port 15, a suction pipe 17 is connected which communicates with a vacuum pump 16 reducing the pressure of the atmosphere inside the processing space K in the processing container 10 to a predetermined degree of vacuum.

Inside the lower container 12, a thermal processing plate 20 as a substrate holding part is provided which mounts and holds the wafer W thereon as illustrated in FIG. 1. In the thermal processing plate 20, a heater (not illustrated) as a thermal processing mechanism generating heat by power feeding is embedded and can thermally process the wafer W on the thermal processing plate 20. The heating temperature of the thermal processing plate 20 is controlled, for example, by a later-described control unit 100. At an outer peripheral portion of the thermal processing plate 20, cutout grooves 21 are formed for housing delivery members 42 of later-described delivery arms 40 in the state that the wafer W is delivered from the deliver arms 40 to the thermal processing plate 20 as illustrated in FIG. 2. The cutout grooves 21 are formed at positions corresponding to the delivery members 42, for example, four locations at the outer peripheral portion of the thermal processing plate 20.

As illustrated in FIG. 1, a cooling plate 22 cooling the wafer W is provided on the lower surface side of the thermal processing plate 20. In the cooling plate 22, a cooling member (not illustrated) such as a Peltier element or a water-cooling jacket is embedded. The cooling temperature of the cooling plate 22 is controlled, for example, by the later-described control unit 100. Note that the cooling plate 22 may be omitted depending on the process of the joint processing of the wafer W.

Inside the processing container 10 and at the upper container 11, a pressurizing mechanism 30 is provided which presses the wafer W on the later-described thermal processing plate 20 toward the thermal processing plate 20. The pressurizing mechanism 30 has a pressing member 31 coming into abutment with the wafer W and pressing the wafer W, an annular member 32 annularly attached to the upper container 11 and supporting the pressing member 31, and a pressurizing bellows 33 connecting the pressing member 31 and the annular member 32 and expandable and contractable in the vertical direction. Inside the pressing member 31, a heater (not illustrated) generating heat, for example, by power feeding is embedded. Then, by supplying or sucking, for example, compressed air to/from the inside of the pressurizing mechanism 30, that is, the inner space surrounded by the pressing member 31, the pressurizing bellows 33, the annular member 32 and the upper container 11, thereby enabling the pressurizing bellows 33 to expand and contact and the pressing member 31 to move in the vertical direction. Note that since the compressed air is enclosed inside the pressurizing mechanism 30, the pressurizing bellows 33 of the pressurizing mechanism 30 is greater in stiffness than the shield bellows 13 of the processing container 10 so as to withstand the internal pressure by the compressed air.

Inside the processing container 10 and at the upper container 11, the delivery arms 40 for delivering the wafer W between a later-described transfer arm 110 and the thermal processing plate 20 are provided. Two delivery arms 40 are provided outside the thermal processing plate 20, for example, as illustrated in FIG. 2. The two delivery arms 40, 40 are provided to face each other with the thermal processing plate 20 intervening between them.

The delivery arm 40 has a support member 41 extending vertically downward from the lower surface of the upper container 11 as illustrated in FIG. 1, delivery members 42 supported by the support member 41 and holding the outer peripheral portion of the wafer W and delivering the wafer W between the transfer arm 110 and the thermal processing plate 20, and coupling members 43 coupling the support member 41 and the delivery members 42 and extending in the horizontal direction. With this configuration, the delivery arm 40 is movable in the vertical direction along with the movement of the upper container 11.

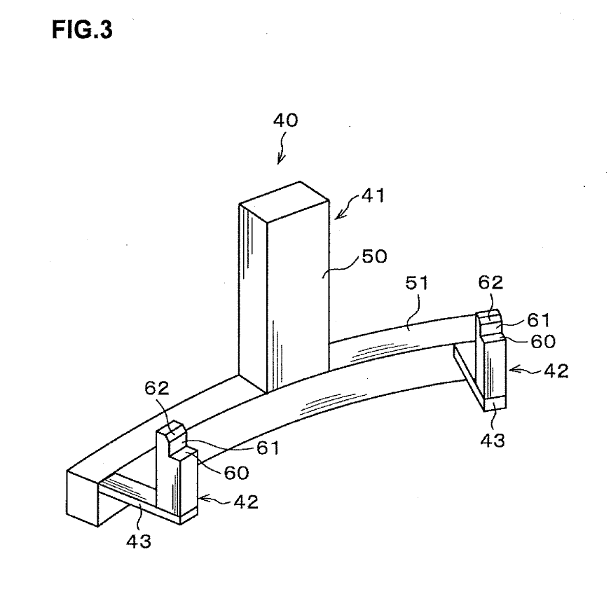

As illustrate in FIG. 3, the support member 41 has a support post 50 extending vertically downward from the lower surface of the upper container 11, and a support beam 51 extending in the horizontal direction along the outer peripheral portion of the thermal processing plate 20 from the lower end of the support post 50. On either side of the support beam 51, a delivery member 42 and a coupling member 43 are provided. With this configuration, the outer peripheral portion of the wafer W is held by the four delivery members 42 as illustrated in FIG. 2. Note that the number of each of the delivery members 42 and the coupling members 43 provided at the support beam 51 is not limited to this embodiment, but may be one or three or more.

As illustrated in FIG. 3, the delivery member 42 has a mounting part 60 mounting the lower surface of the outer peripheral portion of the wafer W, a guide part 61 extending upward from the mounting part 60 and guiding the side surface of the outer peripheral portion of the wafer W, and a tapered part 62 extending upward from the guide part 61 and having the inner surface enlarged in a tapered shape from the lower side to the upper side. The delivery member 42 has an almost rectangular parallelepiped shape.

In the above joint apparatus 1, a control unit 100 is provided as illustrated in FIG. 2. The control unit 100 is, for example, a computer and has a program storage part (not illustrated). In the program storage part, a program is stored which controls the processing of the wafer W in the joint apparatus 1. Note that the program may be the one which is stored, for example, in a computer-readable storage medium H such as a computer-readable hard disk (HD), flexible disk (FD), compact disk (CD), magneto-optical disk (MO), or memory card, and installed from the storage medium H into the control unit 100.

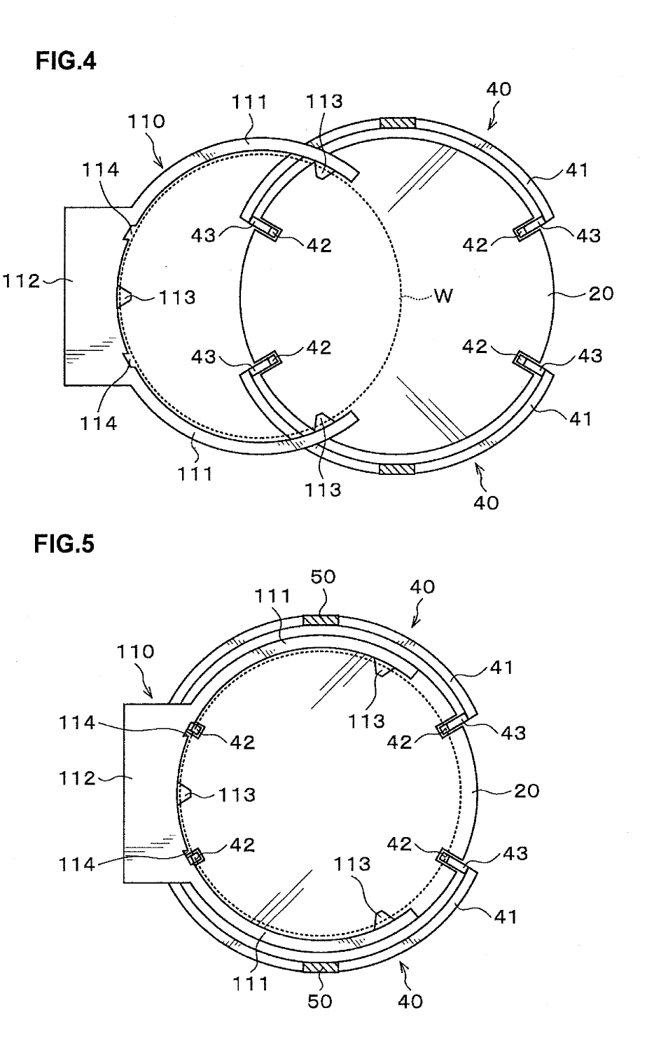

Next, the transfer arm provided outside the joint apparatus 1 will be described. The transfer arm 110 has arm parts 111 extending in a diameter larger than the diameter of the wafer W along the outer peripheral portion of the wafer W and formed in an almost ¾ circular ring shape, and a support part 112 integrally formed with the arm parts 111 and supporting the arm parts 111 as shown in FIG. 4. The arm parts 111 have holding parts 113 projecting inward and holding the outer peripheral portion of the wafer W. The holding parts 113 are provided at, for example, three locations. The transfer arms 110 can horizontally hold the wafer W on the holding parts 113. Further, the support part 112 is formed with cutouts 114 at two locations as illustrated in FIG. 5 to avoid interference between the support part 112 and the delivery members 42 when delivering the wafer W to the deliver arms 40.

Next, the joint processing method of the wafer W performed using the joint apparatus 1 configured as described above will be described.

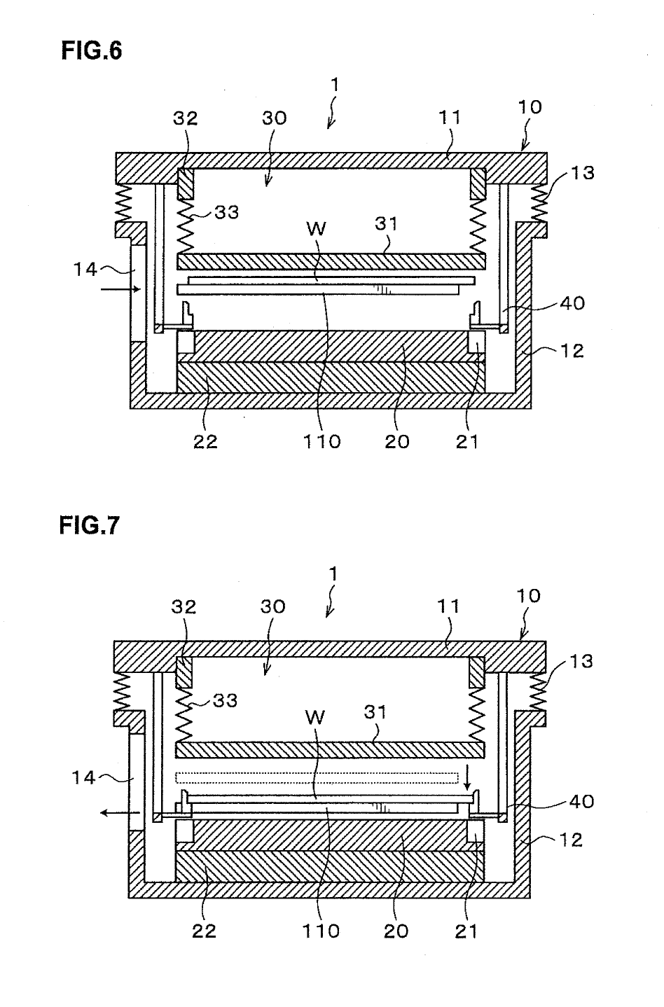

First, the gate valve provided at the joint apparatus 1 is opened, and the wafer W is transferred by the transfer arm 110 into above the thermal processing plate 20 via the transfer-in/out port 14 as illustrated in FIG. 6. In this event, the delivery arms 40 are waiting below the transfer arm 110.

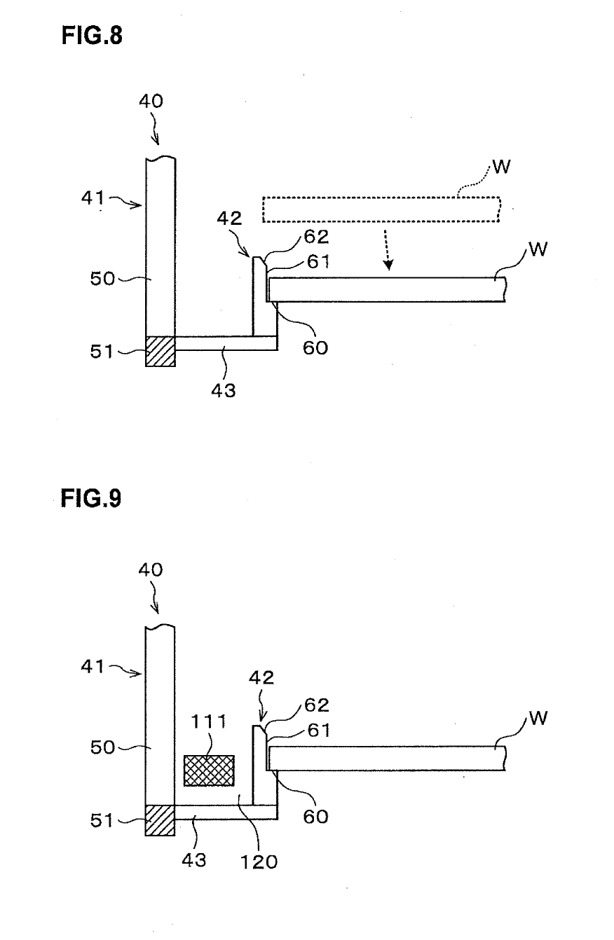

Thereafter, the transfer arm 110 is lowered as illustrated in FIG. 7, and the wafer W is delivered from the transfer arm 110 to the delivery members 42 of the delivery arms 40. In this event, the inner surface of the tapered part 62 at the upper end of the delivery member 42 is enlarged in a tapered shape from the lower side to the upper side as illustrated in FIG. 8, so that even if the wafer W on the transfer arm 110 is located displaced from the inner surface of the guide part 61, the wafer W is smoothly guided by the guide part 61 and held on the mounting part 60. Further, since the support posts 50 of the support members 41 are located outside the transfer arm 110 as illustrated in FIG. 5 and the support part 112 of the transfer arm 110 is formed with the cutouts 114, the transfer arm 110 and the delivery arms 40 never interfere with each other when delivering the wafer W. Note that the delivery of the wafer W from the transfer arm 110 to the delivery arms 40 may be performed by raising the upper container 11 to raise the delivery arms 40.

Thereafter, the transfer arm 110 is moved to the outside of the joint apparatus 1 via the transfer-in/out port 14, and the gate valve is closed. In this event, the arm part 111 of the transfer arm 110 passes through a passage space 120 formed to be surrounded by the support member 41, the delivery member 42, and the coupling member 43 of the delivery arm 40 as illustrated in FIG. 9. Therefore, when the transfer arm 110 moves, the transfer arm 110 and the delivery arm 40 never interfere with each other.

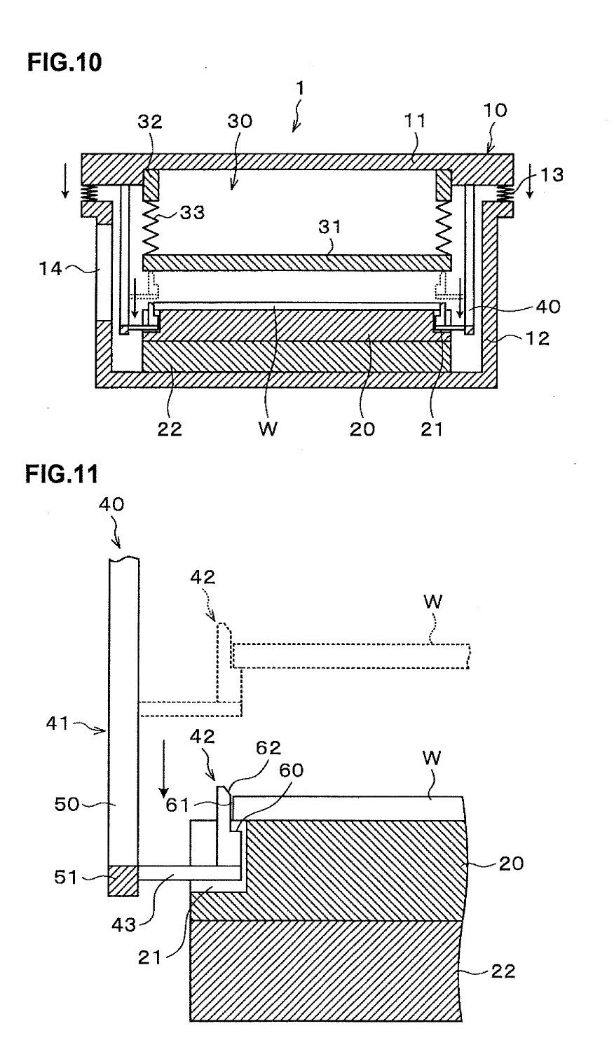

Thereafter, the upper container 11 is lowered to lower the delivery arms 40 as illustrated in FIG. 10 to thereby mount the wafer W on the thermal processing plate 20. The delivery members 42 of the delivery arms 40 are housed in the cutout grooves 21 of the thermal processing plate 20. In this event, the mounting part 60 of the delivery member 42 is housed in the cutout groove 21 to be slightly separate from the lower surface of the wafer W as illustrated in FIG. 11. Further, the tapered part 62 and a part of the guide part 61 project from the cutout groove 21. Then, the wafer W on the thermal processing plate 20 is positioned not to be moved by the guide part 61.

Thereafter, the wafer W is heated by the thermal processing plate 20 to a predetermined temperature, for example, 430° C. In this event, the atmosphere in the processing space K inside the processing container 10 is vacuumed through the suction port 15 by the vacuum pump 16 so that the processing space K is maintained at a predetermined degree of vacuum, for example, a degree of vacuum of 0.1 Pa.

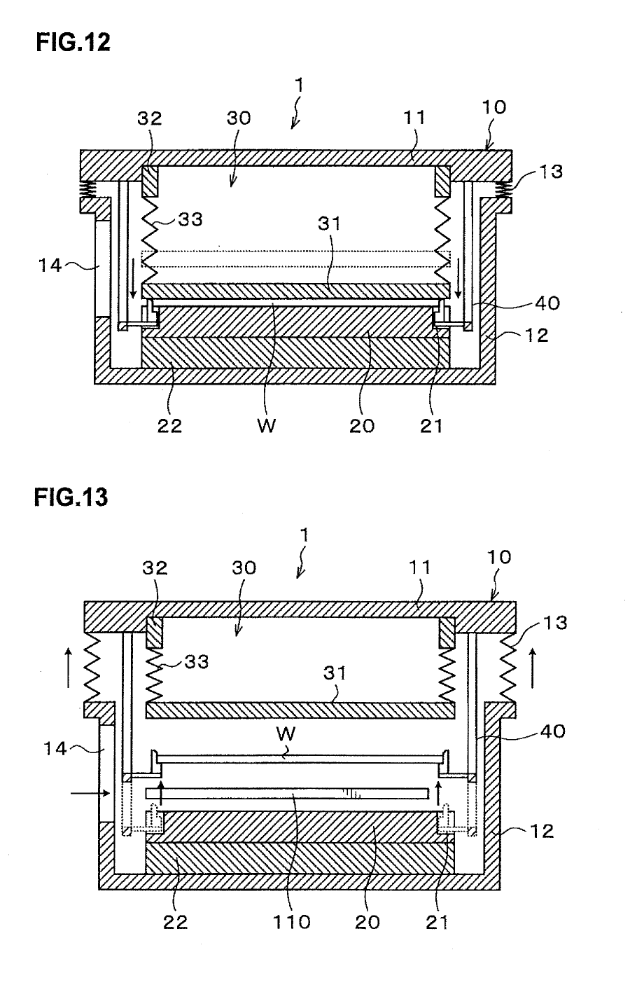

Thereafter, while the temperature of the wafer W is maintained at the predetermined temperature, the compressed air is supplied to the pressurizing mechanism 30 to lower the pressing member 31 as illustrated in FIG. 12. Then, the pressing member 31 is brought into abutment with the wafer W, and the wafer W is pressed toward the thermal processing plate 20 at a predetermined load, for example, 50 kN. Then, the wafer W is pressed for a predetermined time, for example, 10 minutes and thereby joined. Note that the temperature of the wafer W may be maintained using, for example, the heater inside the pressing member 31 or the cooling plate 22.

Thereafter, the wafer W is cooled by the thermal processing plate 20 to a predetermined temperature, for example, 200° C. Note that the cooling of the wafer W may be performed using, for example, the heater inside the pressing member 31 or the cooling plate 22.

After the wafer W is joined, the upper container 11 is raised to raise the delivery arms 40 as illustrated in FIG. 13, whereby the wafer W is delivered from the thermal processing plate 20 to the delivery arms 40. In this event, since the outer peripheral portion of the wafer W is positioned by the guide parts 61, the wafer W is never displaced on the delivery arms 40. Thereafter, the gate valve is opened, and the transfer arm 110 is moved into the processing container 10 via the transfer-in/out port 14. The transfer arm 110 is located below the delivery arms 40 and above the thermal processing plate 20.

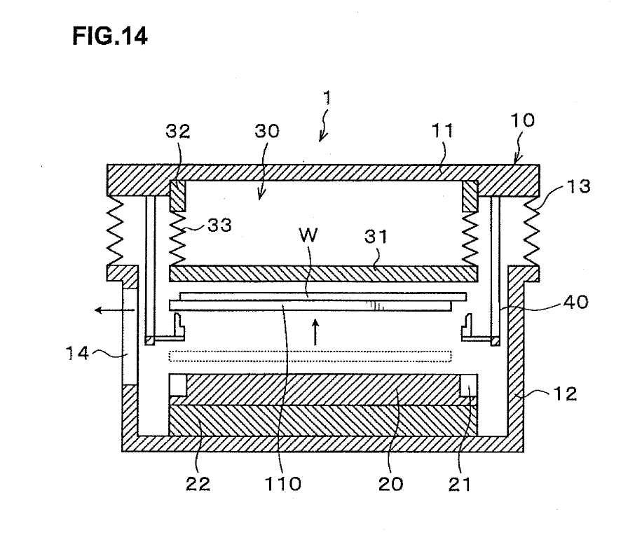

Thereafter, the transfer arm 110 is raised as illustrated in FIG. 14, and the wafer W is delivered from the delivery arms 40 to the transfer arm 110. In this event, since the support posts 50 of the support members 41 are located outside the transfer arm 110 and the support part 112 of the transfer arm 110 is formed with the cutouts 114 as illustrated in FIG. 5, the transfer arm 110 and the delivery arms 40 never interfere with each other when delivering the wafer W. Note that the delivery of the wafer W from the delivery arms 40 to the transfer arm 110 may be performed by lowering the upper container 11 to lower the delivery arms 40.

Thereafter, the wafer W is transferred out of the joint apparatus 1 via the transfer-in/out port 14 by the transfer arm 110. Thus, a series of the joint processing of the wafer W ends.

According to the above embodiment, the delivery arms 40 are configured to be movable in the vertical direction and the cutout grooves 21 are formed at the outer peripheral portion of the thermal processing plate 20, the wafer can be delivered from the delivery arms 40 to the thermal processing plate 20 without interference between the delivery arms 40 and the thermal processing plate 20. Further, since the raising and lowering pin in the prior art becomes unnecessary, a through hole for the raising and lowering pin does not need to be formed in the thermal processing plate 20 and particles below the thermal processing plate 20 never flow out to the processing space. Consequently, processing of the substrate can be appropriately performed.

Further, since the raising and lowering pin in the prior art becomes unnecessary, it is possible to make the processing space K in the processing container 10 smaller than that in the prior art and decrease the time required to vacuum the atmosphere in the processing space K to a predetermined degree of vacuum. In addition, since the delivery arms 40 are provided at the lower surface of the upper container 11, the raising and lowering drive part for the raising and lowering pin in the prior art becomes unnecessary and the processing apace K can be made into a closed space. This makes it possible to bring the inside of the processing space K into the predetermined degree of vacuum.

Further, since the delivery arms 40 rise and lower along with the movement of the upper container 11 in the vertical direction, the raising and lowering pin and the raising and lowering drive part in the prior art become unnecessary. Therefore, the manufacturing cost of the joint apparatus 1 can be reduced. Further, since the delivery arms 40 do not need to be independently moved, the reliability of movement of the delivery arms 40 is increased.

Further, the delivery arms 40 are movable in the vertical direction together with the upper container 11, so that even when the joint processing is performed, for example, on a plurality of wafers W in sequence in the joint apparatus 1, the reproducibility of the heating start time and the pressure reduction start time of the wafer W can be ensured. Consequently, it is possible to suppress variation in the joint processing of the wafer W and improve the stability of the joint processing.

Further, the guide parts 61 of the delivery members 42 can guide the side surface of the outer peripheral portion of the wafer W and therefore prevent the positional displacement of the wafer W on the delivery members 42. This makes it possible to appropriately delivery the wafer W from the delivery arms 40 to the transfer arm 110. In particular, in the case of delivering the wafer W between the transfer arm and the thermal processing plate using the raising and lowering pin in the prior art, there may be positional displacement of the wafer occurring on the raising and lowering pin, but this problem in the prior art can be overcome in this embodiment.

Furthermore, parts of the guide parts 61 project from the cutout grooves 21, so that when the delivery members 42 are housed in the cutout grooves 21 of the thermal processing plate 20, the wafer W on the thermal processing plate 20 can be positioned at an appropriate position. This makes it possible to appropriately perform the joint processing of the wafer W.

Further, the inner surfaces of the tapered parts 62 of the delivery members 42 are enlarged in a tapered shape from the lower side to the upper side, so that even if the wafer W on the transfer arm 110 is located displaced from the inner surfaces of the guide parts 61 when the wafer W is delivered from the transfer arm 110 to the delivery arms 40, the wafer W is smoothly guided by the guide parts 61 and appropriately delivered to the delivery arms 40.

Further, the passage space 120 surrounded by the support members 41, the delivery members 42, and the coupling members 43 is formed in the delivery arms 40, so that when the transfer arm 110 moves to the outside of the joint apparatus 1, the interference between the transfer arm 110 and the delivery arms 40 can be avoided.

Further, since the support beam 51 of the support member 41 supports the two delivery members 42, the configuration of the delivery arm 40 provided in the processing container 10 can be made simpler than that in the case where the delivery member is provide for each support member.

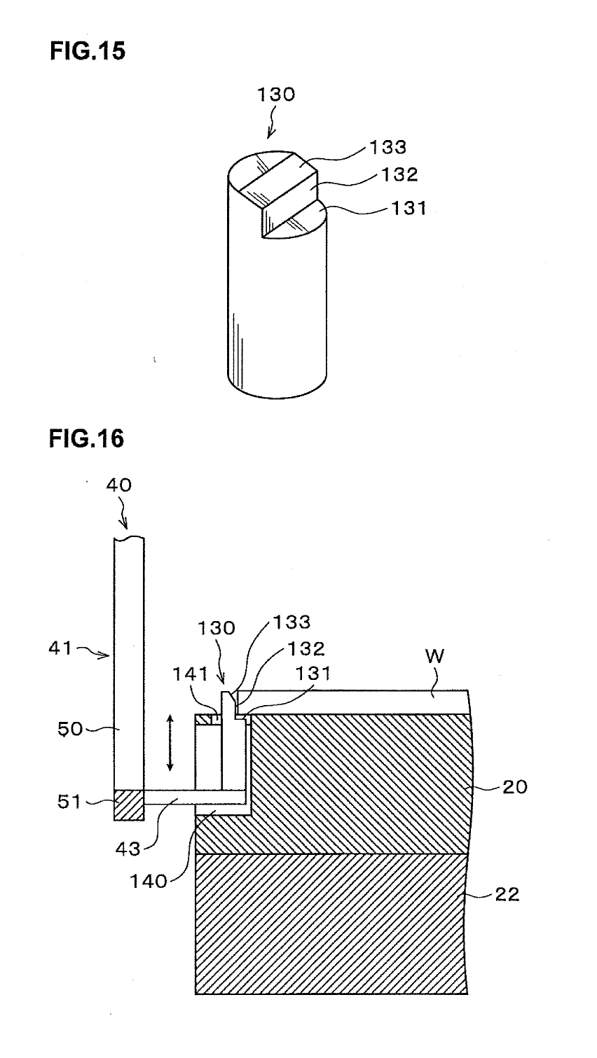

Though the delivery member 42 of the delivery member 40 has an almost rectangular parallelepiped shape in the above embodiment, the delivery member 42 is not limited to have this shape but may employ various shapes. For example, in place of the delivery member 42, a delivery member 130 in an almost cylindrical shape as illustrated in FIG. 15 may be used. Note that the other configuration of the delivery arm 40 is the same as that of the delivery arm 40 illustrated in FIG. 3 and the description thereof will be omitted.

The delivery member 130 has a mounting part 131 mounting the lower surface of the outer peripheral portion of the wafer W, a guide part 132 extending upward from the mounting part 131 and guiding the side surface of the outer peripheral portion of the wafer W, and a tapered part 133 extending upward from the guide part 132 and having the inner surface enlarged in a tapered shape from the lower side to the upper side. Note that the mounting part 131, the guide part 132, and the tapered part 133 are formed by cutting the upper portion of the delivery member 130 in the cylindrical shape.

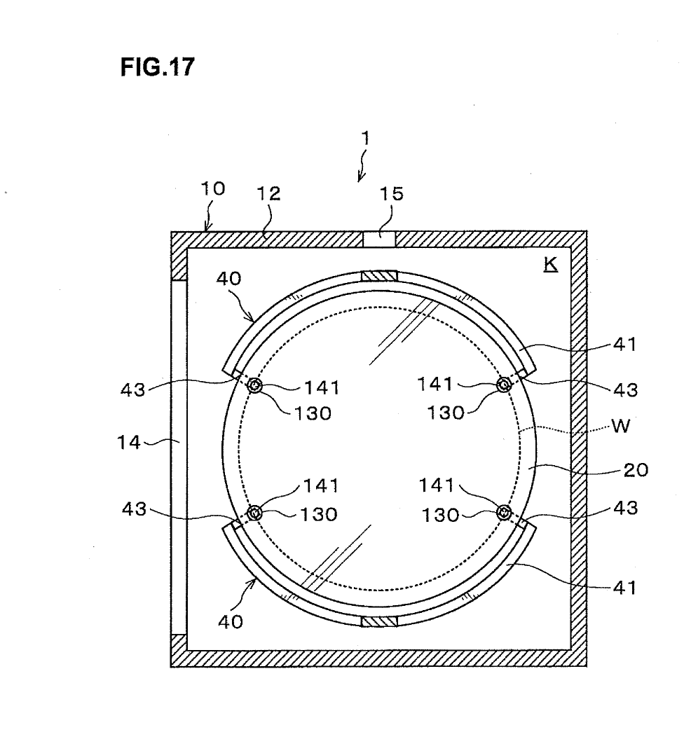

In this case, a cutout groove 140 is formed in a hollow between the upper and lower surfaces of the thermal processing plate 20 at the outer peripheral portion of the thermal processing plate 20, for example, as illustrated in FIG. 16. In the cutout groove 140, the delivery member 130 is disposed. Further, a through hole 141 for allowing the delivery member 130 to pass through is formed at a position corresponding to the delivery member 130 in the upper surface of the thermal processing plate 20. The through hole 141 has a circular shape in a plan view having a diameter slightly larger than that of the delivery member 130. With this configuration, the delivery member 130 is configured to be movable in the vertical direction in the cutout groove 140, and the coupling member 43 never moves to above the cutout groove 140. Further, when the wafer W is mounted on the thermal processing plate 20, that is, when the delivery arm 40 moves to the lowermost side, the tapered part 133 and a part of the guide part 132 project from the through hole 141 so that the wafer W is positioned by the guide part 132. Note that the through hole 141 (cutout groove 140) is formed at each of four locations in conformity with the number of the delivery members 130 as illustrated in FIG. 17.

According to the above embodiment, the through holes 141 are formed only at the four locations in the upper surface of the thermal processing plate 20, the strength of the thermal processing plate 20 can be improved. This makes it possible to increase the load when the pressurizing mechanism 30 presses the wafer W. Further, since the outer peripheral portion of the wafer W is supported by the thermal processing plate 20 other than the through holes 141, the load distribution on the wafer W can be made substantially uniform within the wafer when the wafer W is pressed. Accordingly, the wafer W can be more appropriately joined. In addition, the same effects as those in the above embodiment can be provided also in this embodiment.

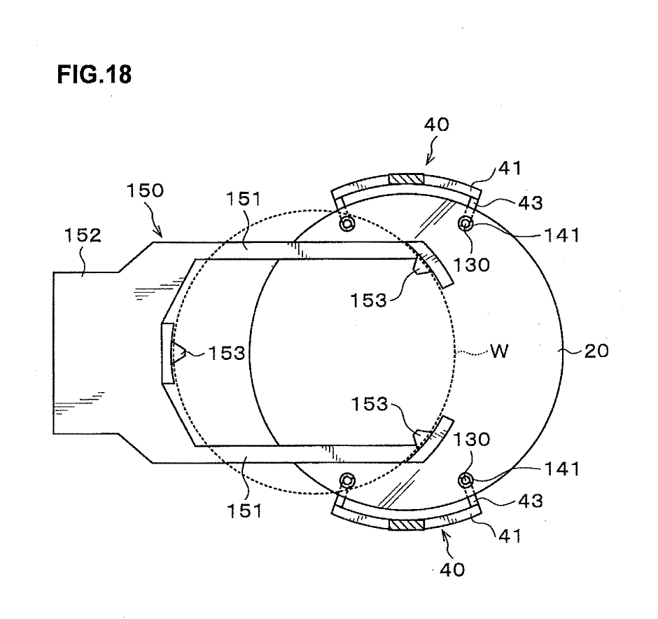

Though the transfer arm 110 in the above embodiment has the arm parts 111 configured in an almost ¾ circular ring shape, the transfer arm 110 is not limited to have this shape but can take various forms. For example, as illustrated in FIG. 18, a transfer arm 150 has two arm parts 151, 151 linearly extending in the horizontal direction, and a support part 152 integrally formed with the arm parts 151 and supporting the arm parts 151. The two arm parts 151, 151 are arranged such that an interval between them is smaller than the diameter of the wafer W. The transfer arm 150 has holding parts 153 projecting inward to hold the outer peripheral portion of the wafer W. The holding parts 153 are provided, for example, three locations. The transfer arm 150 can horizontally hold the wafer W on the holding parts 153. Note that in place of the holding parts 153, suction pads may be provided on the arm parts 151 to hold the lower surface of the wafer

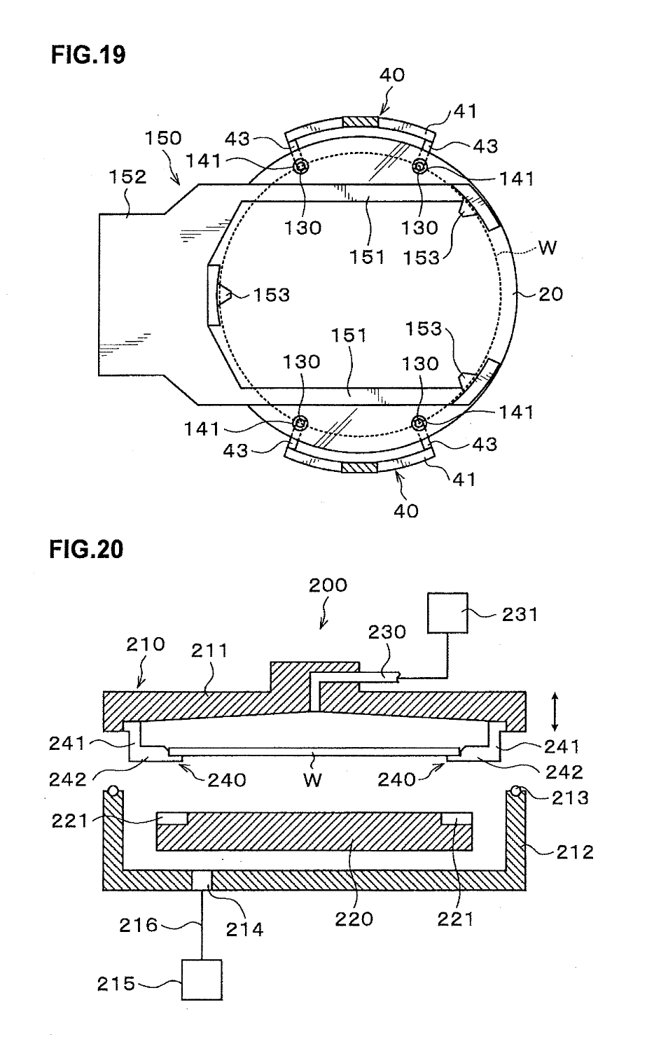

The delivery members 130 of the delivery arms 40 are provided outside the arm parts 151. Further, the through holes 141 and the cutout grooves 140 of the thermal processing plate 20 are also formed at positions corresponding to the delivery members 130. In this case, when the wafer W is delivered between the transfer arm 150 and the delivery arms 40 as illustrated in FIG. 19, the interference between the transfer arm 150 and the delivery arms 40 can be avoided. Further, the same effects as those in the above embodiment can be provided also in this embodiment. Note that in place of the delivery members 130, the delivery members 42 may be used in this embodiment.

Though the joint apparatus 1 performing joint processing on the wafer W has been described as the substrate processing apparatus in the above embodiments, the delivery arms 40 are also applicable to a hydrophobic treatment apparatus performing hydrophobic treatment on the front surface of the wafer W. Note that a case where a delivery arm with a configuration different from that of the delivery arm 40 will be described in the embodiment described below.

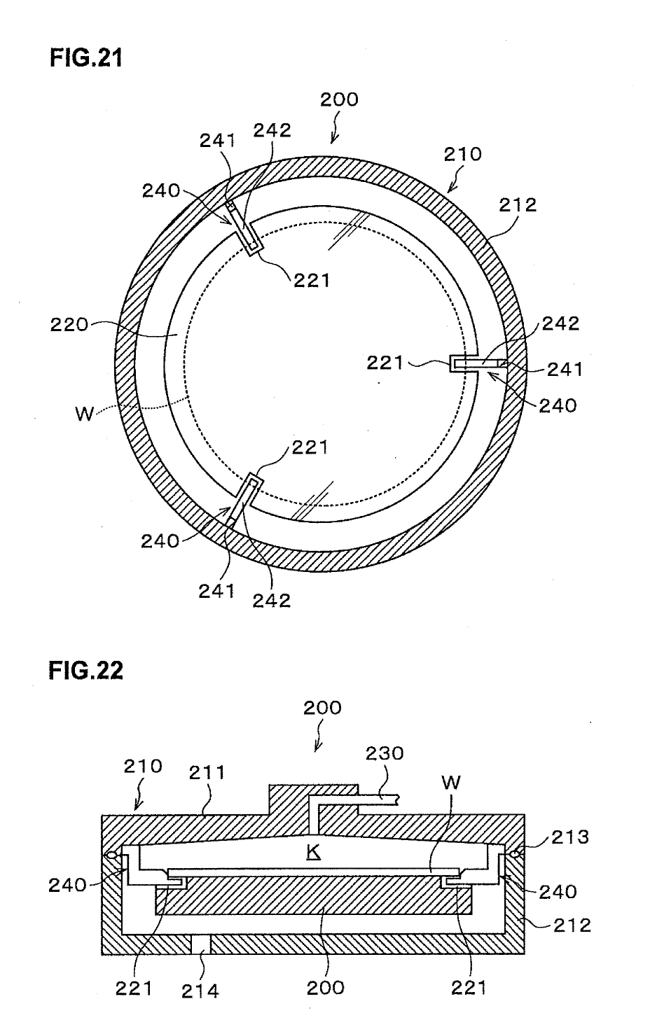

As illustrated in FIG. 20 and FIG. 21, a hydrophobic treatment apparatus 200 has a treatment container 210 capable of closing the inside thereof. Note that though the hydrophobic treatment apparatus 200 has a configuration that a cooling plate mounting and cooling the wafer W thereon and so on are arranged in a casing in addition to the treatment container 210, the configuration, operation, effect of the treatment container 210 and the inside thereof will be described here. In addition, the case of using the transfer arm 150 having the two arm parts 151, 151 linearly extending in the horizontal direction illustrated in FIG. 18 and FIG. 19 as a transfer arm transferring the wafer W to/from the hydrophobic treatment apparatus 200 will be described in this embodiment.

The treatment container 210 has a configuration that an upper container 211 located on the upper side and a lower container 212 located on the lower side are arranged to face each other. The upper container 211 is configured to be movable in the vertical direction by means of, for example, a raising and lowering mechanism (not illustrated). Further, the upper container 211 has an almost cylindrical shape with its lower surface open, and the lower container 212 has an almost cylindrical shape with its upper surface open. With this configuration, the upper container 211 is lowered toward the lower container 212, and the upper container 211 and the lower container 212 are united into one body to form a processing space K for performing hydrophobic treatment on the wafer W inside the upper container 211 and the lower container 212 as illustrated in FIG. 22. Note that to make the processing space K into a closed space, an annular sealing member, for example, an O-ring 213 made of resin is provided on the upper surface of the side wall of the lower container 212.

In the bottom surface of the lower container 212, an exhaust port 214 is formed as illustrated in FIG. 20. To the exhaust port 214, an exhaust pipe 216 is connected which communicates with a vacuum means 215 such as an ejector or a pump exhausting the atmosphere in the processing space K inside the treatment container 210.

Inside the lower container 212, a thermal processing plate 220 as a substrate holding part is provided which mounts and holds the wafer W thereon. The thermal processing plate 220 is supported by the lower container 212 via a support member (not illustrated). In the thermal processing plate 220, a heater (not illustrated) as a thermal processing mechanism generating heat, for example, by power feeding is embedded and can thermally process the wafer W on the thermal processing plate 220. The heating temperature of the thermal processing plate 220 is controlled, for example, by the above-described control unit 100. At an outer peripheral portion of the thermal processing plate 220, cutout grooves 221 are formed for housing delivery members 242 of later-described delivery arms 240 in the state that the wafer W is delivered from the deliver arms 240 to the thermal processing plate 220 as illustrated in FIG. 21. The cutout grooves 221 are formed at positions corresponding to the delivery members 242, for example, three locations at the outer peripheral portion of the thermal processing plate 220.

At the upper portion of the upper container 211, a gas supply pipe 230 for supplying a hydrophobic treatment gas, for example, an HMDS (hexamethyldisilazane) gas into the processing space K is provided as illustrated in FIG. 20. The gas supply pipe 230 is arranged such that one end portion is opened at the middle of the lower surface of the upper container 211. Further, the other end portion of the gas supply pipe 230 is connected to a gas supply source 231 for generating the HMDS gas and supplying the HMDS gas to the gas supply pipe 230.

Inside the treatment container 210 and at the upper container 211, the delivery arms 240 for delivering the wafer W between the above-described transfer arm 150 and the thermal processing plate 220 are provided. The delivery arms 240 are provided at three locations at regular intervals on the same circumference with the thermal processing plate 220, for example, as illustrated in FIG. 21.

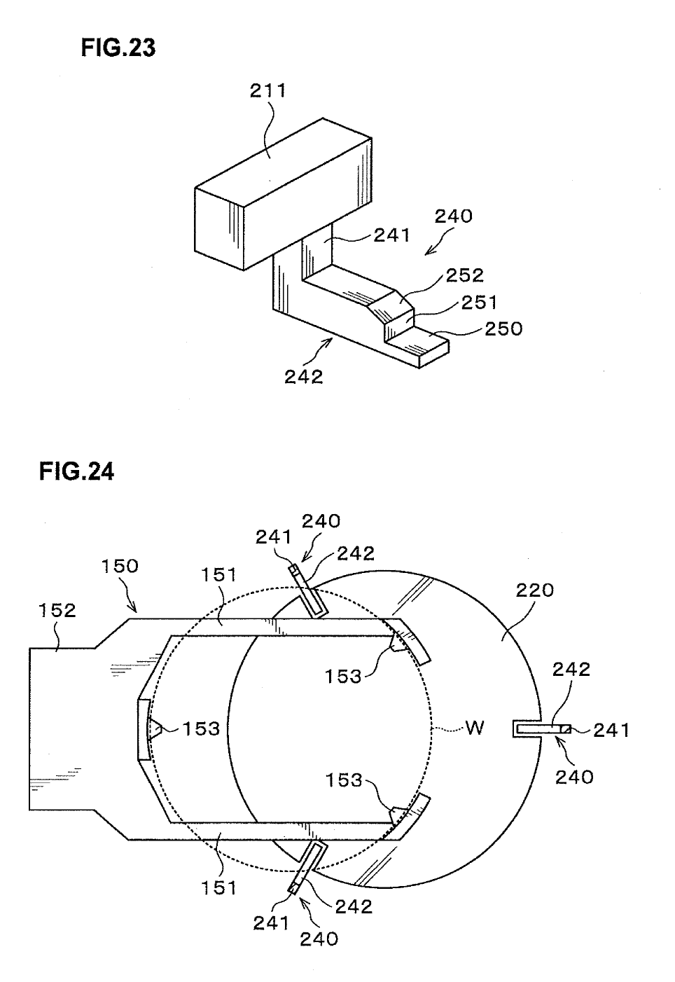

The delivery arm 240 has a support member 241 extending vertically downward from the lower surface of the upper container 211, and a delivery arm 242 supported by the support member 241 and holding the outer peripheral portion of the wafer W and delivering the wafer W between the transfer arm 150 and the thermal processing plate 220 as illustrated in FIG. 23. With this configuration, the delivery arm 240 is movable in the vertical direction along with the movement of the upper container 211.

The delivery member 242 has a mounting part 250 mounting the lower surface of the outer peripheral portion of the wafer W, a guide part 251 extending upward from the mounting part 250 and guiding the side surface of the outer peripheral portion of the wafer W, and a tapered part 252 extending upward from the guide part 251 and having the inner surface enlarged in a tapered shape from the lower side to the upper side.

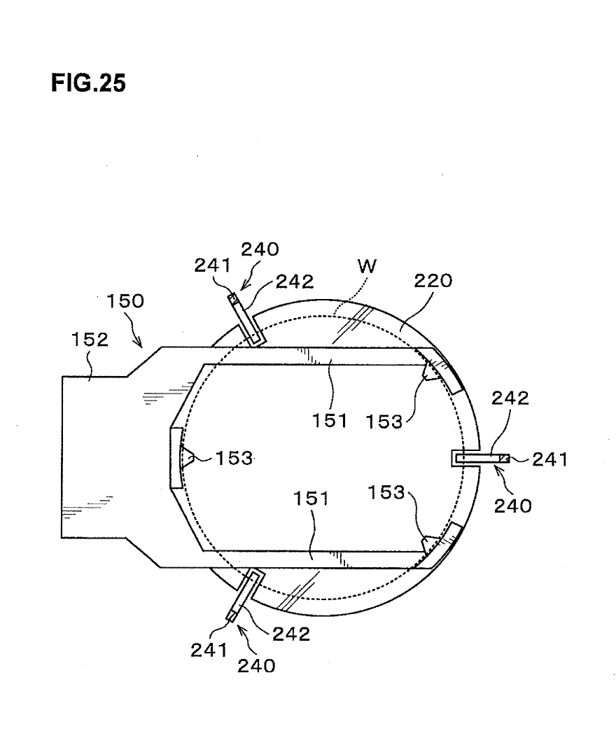

The delivery members 242 are provided outside the arm parts 151 of the transfer arm 150 as illustrated in FIG. 24. In this case, when delivering the wafer W between the transfer arm 150 and the delivery arms 240 as illustrated in FIG. 25, the interference between the transfer arm 150 and the delivery arms 240 can be avoided.

According to this embodiment, it is unnecessary to provide the support beam at the support member 241 of the delivery arm 240, and the support member 241 can directly support the support member 242. Accordingly, the configuration of the delivery arm 240 can be simplified. In addition, the same effects as those in the above embodiment can be provided also in this embodiment.

Note that the upper container 11 is configured to be movable in the vertical direction and the lower container 12 is fixed and not moved in the above embodiment. However, the upper container 11 may be fixed and not moved and the lower container 12 may be movable in the vertical direction, and the same effects can be provided also in this case. Accordingly, the upper container 11 and the lower container 12 only need to be relatively movable in the vertical direction to freely approach and separate to/from each other.

Preferred embodiments of the present invention have been described above with reference to the accompanying drawings, but the present invention is not limited to the embodiments. It should be understood that various changes and modifications are readily apparent to those skilled in the art within the scope of the spirit as set forth in claims, and those should also be covered by the technical scope of the present invention. The present invention is not limited to the embodiments but can take various forms. The present invention is also applicable to the case where the substrate is a substrate other than the wafer, such as an FPD (Flat Panel Display), a mask reticle for a photomask or the like.

### EXPLANATION OF CODES

1 joint apparatus
10 processing container
11 upper container
12 lower container
20 thermal processing plate
21 cutout groove
40 delivery arm
41 support member
42 delivery member
43 coupling member
50 support post
51 support beam
60 mounting part
61 guide part
62 tapered part
100 control unit
110 transfer arm
111 arm part
120 passage space
130 delivery member
131 mounting part
132 guide part
133 tapered part
140 cutout groove
141 through hole
150 transfer arm
151 arm part
200 hydrophobic treatment apparatus
210 processing container
211 upper container
212 lower container
220 thermal processing plate
221 cutout groove
240 delivery arm
241 support member
242 delivery member
K processing space
W wafer

What is claimed:

1. A substrate processing apparatus, comprising:
an upper container;
a lower container provided below said upper container to face said upper container, movable in a vertical direction relative to said upper container, and uniting with said upper container into one body to form a processing space for the substrate therein;
a substrate holding part provided inside said lower container and mounting and holding the substrate thereon; and
a delivery arm including a support member extending vertically downward from a lower surface of said upper container, and a delivery member supported by said support member and holding an outer peripheral portion of the substrate and delivering the substrate to/from said substrate holding part,
wherein said delivery arm is movable together with said upper container in the vertical direction relative to said lower container, and
wherein a cutout groove capable of housing said delivery member is formed at a position corresponding to said delivery member at the outer peripheral portion of said substrate holding part.

2. The substrate processing apparatus as set forth in claim 1,
wherein said upper container is movable in the vertical direction, and said lower container is fixed and not moved.

3. The substrate processing apparatus as set forth in claim 1,
wherein said delivery member includes:
a mounting part mounting a lower surface of the outer peripheral portion of the substrate thereon;
a guide part extending upward from said mounting part and guiding a side surface of the outer peripheral portion of the substrate; and
a tapered part extending upward from said guide part and having an inner surface enlarged in a tapered shape from a lower side to an upper side.

4. The substrate processing apparatus as set forth in claim 3,
wherein at least a part of said guide part projects from said cutout groove in a state that said delivery member is housed in said cutout groove.

5. The substrate processing apparatus as set forth in claim 3,
wherein said delivery member has a cylindrical shape,
wherein said mounting part, said guide part, and said tapered part are formed by cutting an upper portion of said delivery member,
wherein said cutout groove is formed between upper and lower surfaces of said substrate holding part, and
wherein a through hole for allowing said delivery member to pass through is formed at a position corresponding to said delivery member in an upper surface of said substrate holding part.

6. The substrate processing apparatus as set forth in claim 1,
wherein said support member includes:
a support post extending vertically downward from a lower surface of said upper container; and
a support beam extending in a horizontal direction along the outer peripheral portion of said substrate holding part from a lower end of said support post, and
wherein a plurality of said delivery members are provided on said support beam.

7. The substrate processing apparatus as set forth in claim 1,
wherein said delivery arm delivers the substrate to/from a transfer arm outside said substrate processing apparatus,
wherein said transfer arm includes an arm part holding the substrate and extending in a diameter larger than a diameter of the substrate along the outer peripheral portion of the substrate,
wherein a coupling member extending in the horizontal direction is provided between said support member and said delivery member, and
wherein a passage space formed to be surrounded by said support member, said delivery member and said coupling member is configured to allow said arm part to pass through.

8. The substrate processing apparatus as set forth in claim 1,
wherein said delivery arm delivers the substrate to/from a transfer arm outside said substrate processing apparatus,
wherein said transfer arm includes two arm parts holding the substrate and linearly extending at an interval smaller than a diameter of the substrate, and
wherein said delivery member is provided outside said arm part.

9. The substrate processing apparatus as set forth in claim 1,
wherein said substrate holding part has a thermal processing mechanism thermally processing the substrate on said substrate holding part.

10. The substrate processing apparatus as set forth in claim 1,
wherein said substrate processing apparatus performs joint processing of a superposed substrate in which substrates are superposed.

11. The substrate processing apparatus as set forth in claim 1,
wherein said substrate processing apparatus performs hydrophobic treatment on a front surface of the substrate.

12. A substrate processing method using a substrate processing apparatus,
the substrate processing apparatus comprising:
an upper container;
a lower container provided below the upper container to face the upper container, movable in a vertical direction relative to the upper container, and uniting with the upper container into one body to form a processing space for the substrate therein;
a substrate holding part provided inside the lower container and mounting and holding the substrate thereon; and
a delivery arm including a support member extending vertically downward from a lower surface of the upper container, and a delivery member supported by the support member and holding an outer peripheral portion of the substrate and delivering the substrate to/from the substrate holding part,
said substrate processing method comprising:
lowering the upper container relative to the lower container toward the substrate holding part, and lowering the delivery arm holding the substrate relative to the lower container toward the substrate holding part;
housing the delivery member in a cutout groove formed in the substrate holding part, and delivering the substrate from the delivery arm onto the substrate holding part; and
performing predetermined processing on the substrate in a state that the delivery member is housed in the cutout groove.

13. The substrate processing method as set forth in claim 12,
wherein the substrate on the substrate holding part is thermally processed by a thermal processing mechanism provided in the substrate holding part.

14. The substrate processing method as set forth in claim 12,
wherein the predetermined processing is joint processing of a superposed substrate in which substrates are superposed.

15. The substrate processing method as set forth in claim 12,
wherein the predetermined processing is hydrophobic treatment on a front surface of the substrate.

16. A program running on a computer of a control unit controlling a substrate processing apparatus to cause the substrate processing apparatus to execute a substrate processing method,
the substrate processing apparatus comprising:
an upper container;
a lower container provided below the upper container to face the upper container, movable in a vertical direction relative to the upper container, and uniting with the upper container into one body to form a processing space for the substrate therein;
a substrate holding part provided inside the lower container and mounting and holding the substrate thereon; and
a delivery arm including a support member extending vertically downward from a lower surface of the upper container, and a delivery member supported by the support member and holding an outer peripheral portion of the substrate and delivering the substrate to/from the substrate holding part, and
the substrate processing method comprising:
lowering the upper container relative to the lower container toward the substrate holding part, and lowering the delivery arm holding the substrate relative to the lower container toward the substrate holding part;
housing the delivery member in a cutout groove formed in the substrate holding part, and delivering the substrate from the delivery arm onto the substrate holding part; and
performing predetermined processing on the substrate in a state that the delivery member is housed in the cutout groove.

17. A readable computer storage medium storing a program running on a computer of a control unit controlling a substrate processing apparatus to cause the substrate processing apparatus to execute a substrate processing method,
the substrate processing apparatus comprising:
an upper container;
a lower container provided below the upper container to face the upper container, movable in a vertical direction relative to the upper container, and uniting with the upper container into one body to form a processing space for the substrate therein;
a substrate holding part provided inside the lower container and mounting and holding the substrate thereon; and
a delivery arm including a support member extending vertically downward from a lower surface of the upper container, and a delivery member supported by the support member and holding an outer peripheral portion of the substrate and delivering the substrate to/from the substrate holding part, and
the substrate processing method comprising:
lowering the upper container relative to the lower container toward the substrate holding part, and lowering the delivery arm holding the substrate relative to the lower container toward the substrate holding part;
housing the delivery member in a cutout groove formed in the substrate holding part, and delivering the substrate from the delivery arm onto the substrate holding part; and
performing predetermined processing on the substrate in a state that the delivery member is housed in the cutout groove.
